(19) United States
(12) Patent Application Publication
(10) Pub. No.: US 2005/0076628 A1
(43) Pub. Date: Apr. 14, 2005

(54) Ground supported motorized sickle bar mower for use on sloping terrain

(76) Inventor: Richard W. Law, Lewiston, ID (US)

Correspondence Address: KEITH S BERGMAN;ATTORNEY AT LAW, 7 SOUTH HOWARD STREET, SUITE 418, SPOKANE, WA, 992013898, US

(21) Appl. No.: 10/682,564

(22) Filed: Oct. 10, 2003

(51) Int. Cl. A01D 34/13

(52) U.S. Cl. 56/264

(57) ABSTRACT

A motorized mower provides an elongate frame journaling two elongately spaced co-planar wheels for ground support and supporting a rearwardly and upwardly extending handle for manipulation. The frame carries a powering structure having a motor carried on a depending powering column carried for adjustable vertical positioning by the frame and communicating with a lowermost transmission structure. The transmission structure carries a reciprocating double-sided sickle extending laterally from the frame for adjustable pivotal positioning in a laterally extending vertical plane. The frame is of releasable compound nature to allow folding of the handle and sickle bar for compaction during periods of non-use.

### I. BACKGROUND OF INVENTION

1. IIA. Related Applications

There are no applications related hereto heretofore filed in this or in any foreign country by the Applicant.

2. IIB. Field f Invention

My invention relates generally to a ground-supported mower having two in-line wheels and a motorized laterally extending pivotally mounted sickle bar cutter adjustably movable vertically and pivotally in a vertical plane.

### IIC. BACKGROUND AND DESCRIPTION OF PRIOR ART

Lawns and lawn-like herbage structures have been a desirable element of landscape architecture since its earliest times and various tools such as mowers and other mechanical cutters have long been known to maintain the herbage in a uniformly trimmed and aesthetically pleasing state.

Many, if not most, herbage structures heretofore existent have been of a reasonably planar nature and in general of a somewhat horizontal orientation probably to some degree because of the potential for easier creation and maintenance of this type of structure. Many of the mowers for use on this type of an herbage structure have been particularly adapted and designed for use on substantially planar horizontal structures. Two of the most common type of such modern day mowers are the reel type mower having a cylindrical cutter head rotatable about an axis parallel to an associated cutting bar and generally parallel to a surface supporting the mower and the presently more popular rotary mower having a cutting blade rotating about an axis substantially perpendicular to a surface supporting the mower. Both of these mower types generally are supported at at least three spaced sets of rotatable wheels or rollers that tend to maintain the cutting plane of the mower parallel to a plane extending through the three points of contact of the mower with an underlying supporting surface. This structure in essence makes these types of mowers effectively operable only on substantially planar surfaces of a reasonably horizontal orientation because the mower will tend to move in a straight line only on an underlying horizontal planar supporting surface and will tend to move angularly to a contour line on a sloping surface if the mower moves without slippage of its rolling elements on the supporting surface.

Often herbage structures are created on somewhat regular surfaces that are curvilinear in two or three mutually perpendicular planes, such as on the surface of a hill or ridge of non-uniform curvature. On such surfaces it is generally most convenient and desirable to mow vegetation in a patternation such as on contour lines, on parallel lines uniformly angulated to contour lines or on lines uniformly spaced from the periphery or some portion thereof of the herbage structure being mowed. In each case the use of a traditional reel or rotary mower is not particularly practical or desirable as either type of mower by reason of its at least three point rolling support will tend to follow a straight line course tangent to a curve sought to be transversed. The mower can be maintained on a curvilinear course only by manually manipulating the mower to continuously change steerage or to cause slippage of the wheels supporting the lower on the underlying surface, either of which manipulation often are difficult to accomplish. If a mower supported on rolling supports journaled on spaced laterally extending axles or a single elongately extending axle moves on a contour line of a hill, the wheel on the higher side of the hill will traverse a course having a shorter length than that traversed by the wheel or roller portion on the lower side of the hill to cause the mower to follow a course tangential to the hill contour rather than to follow along that contour.

To resolve this problem the instant mower provides two relatively thin wheels for support on an underlying surface, but provides those wheels in an elongately spaced co-planar relationship, so that each wheel traverses substantially the same distance along a contour line of a hill over which the mower moves. This elongately spaced co-planar wheel structure provides substantially the same stability of motion and ease of steerage over a curvilinear course that the traditional two elongately spaced sets of two laterally spaced wheels or rollers do over a linear course on a planar surface.

Mower structures having a single support wheel for locomotion have heretofore been known. With single wheel mowers, however, the horizontal orientation of the mower frame in a plane through the supporting the wheel must be continuously controlled by an operator, whereas with two elongately spaced co-planar wheels the horizontal orientation is more constant and need not be continuously controlled by the operator to provide more accurate and easier operation of the mower having two elongately spaced wheels.

It is desirable, and nearly necessary for practical use, that a mower have means for adjusting the height of a cut surface of herbage relative to the supporting surface beneath the mower in which the herbage grows. In general in both the common reel and rotary type mowers this adjustment has been provided by adjusting the vertical position of the body of the mower relative to the wheels supporting the mower body on the underlying surface. This type of adjustment has often proven cumbersome, difficult and inaccurate in mowers having multiple wheels, as generally structures supporting each wheel, or at least each opposed pair of wheels, must be adjusted relative to the mower body for any substantial amount of vertical adjustment. In some mowers smaller amounts of vertical adjustment have been accomplished by adjusting only one set of elongately spaced wheels relative to the other so that the mower body carrying the cutting device is angulated in an elongate direction, but doing this generally can provide only a limited vertical adjustment and may cause problems in the cutting operation, in providing a uniform cut surface and in avoiding small irregularities extending upwardly from the general underlying earth surface.

The instant mower solves this problem in a different fashion by providing a columnar type powering structure mounted on the mower frame for adjustable vertical positioning relative to the frame to allow vertical adjustment of cutter structure carried by the powering structure relative to the frame rather than changing the amount of dependency of the supporting wheels relative to the frame. To accomplish this adjustment the powering structure provides a vertical column for support on the mower frame with a motor at the upper portion of the column, a power shaft communicating vertically powering downward through the column and a sickle type mowing bar carried at the lower portion of the powering column to operatively communicating with the shaft so that the whole powering structure may be moved vertically relative to the supporting mower frame to adjustably regulate the cutting level.

For a mower having a cutter structure extending laterally from the mower frame to operate on an angulated surface by following contour lines and provide a uniformly cut vegetative surface substantially parallel to the earth supporting the herbage structure, it is necessary that the mower frame be angulated from the vertical or that the cutter structure be angulated relative to the mower frame. The instant mower provides pivotal mounting for the cutter structure on the powering column to allow adjustable pivotal motion of a cutter bar in a vertical laterally extending plane to provide the desired cut surface of herbage. To accommodate this motion of the cutting head it is driven through an angulated gear type transmission linkage with the powering shaft, which remains in continuous mechanical interconnection through a substantial pivotal motion of the cutting head of at least 120°.

Often herbage on steeper surfaces is of a heavier and more coarse nature than vegetation on substantially flat lawns. By reason of this the instant mower provides a reciprocating sickle bar type cutter structure that preferably has two notched blades that reciprocate relative to each other to cut herbage in the notches of the blades as they move relative to each other. This type of sickle bar cutter allows the instant mower cut coarser herbaceous material such as large overgrown grass plants and smaller bushes, brush and vines while yet cutting finer lawn grass stems as well as the common present day reel and rotary type mowers. It also is often convenient in cutting herbaceous material on sloped surfaces to be able to cut that material in either a forward or rearward direction. To accommodate this function the instant cutter bar is of a double-sided type having notched tooth structures as described on both the forward side and the rearward side of the sickle bar.

The structure of the instant invention is also such as to allow ready folding or unfolding between a more compact mode for storage and a less compact assembled form for use, while still providing all of the other described use features.

My invention resides not in any one of the foregoing features individually, but rather in the synergistic combination of all of its structures that necessarily give rise to the functions flowing therefrom as herein specified and claimed.

### III. SUMMARY OF INVENTION

The instant provides a peripherally defined frame having a rearward upwardly extending manipulating handle and journaling two elongately spaced co-planar wheels at each end of the frame for ground support. The medial portion of the frame between the wheels carries a vertically oriented powering structure having a medial powering column supported for adjustable vertical positioning on the frame with a motor at the upper portion of the powering column operatively communicating with a powering shaft depending through the powering column and carrying a transmission structure at the lower portion of the powering column. The transmission structure pivotally carries a double-edged sickle bar type cutter extending laterally therefrom for adjustable angular positioning in a vertical laterally extending plane while remaining in operative interconnection with the transmission structure to provide reciprocal oscillatory motion of two adjacent cutter blades in the sickle bar. The mower optionally may be of a foldable nature to provide a less bulky structure for storage or transport during periods of non-use and a fully assembled structure for use.

In creating such a mechanism:

A principal object is to provide a mower to effectively cut both finer vegetation and coarser herbage on sloped terrain by use of a laterally extending sickle-cutting bar.

A further object is to provide such a mower having a frame with an upwardly and rearwardly extending manipulative handle and two elongately spaced co-planar medially positioned supporting wheels.

A further object is to provide such a mower having a powering structure, with a medial powering column carried by the mower frame for adjustable vertical positioning relative to the mower frame.

A further object is to provide such a mower wherein the powering structure has a vertical column with a motor at its upper end portion communicating by a powering shaft depending through the column with a transmission structure in its lower end portion pivotally mounting a sickle bar for motion in a laterally extending vertical plane.

A further object is to provide a bevel gear type transmission communicating between the power shaft and the sickle bar that allows angular pivotal motion of the sickle bar while maintaining continuous geared communication between the sickle bar and the power shaft.

A still further object is to provide such a mower with pivotal adjustable motion of the sickle bar between a plurality of user selectable angular positions.

A still further object is to provide such a mower that has a double-edged oscillating sickle bar that cuts in either a forward or rearward direction.

A still further object is to provide such a mower that is of new and novel design, of rugged and durable nature, of simple and economic manufacture and otherwise well suited to the uses and purposes of which it is intended.

Other and further objects of my invention will appear from the following specification and accompanying drawings which form a part hereof. In carrying out the objects of my invention, however, it is to be understood that its essential features are susceptible of change in design and structural arrangement with only one preferred and practical embodiment of the best known mode being illustrated and specified as is required.

### IV. BRIEF DESCRIPTION OF THE DRAWINGS

In the accompanying drawings which form a part hereof and wherein like numbers of references refer to similar parts throughout:

FIG. 1 is a forward looking isometric view of the right side of the mower with the sickle bar in a horizontal position.

FIG. 2 is a forward looking isometric view taken from the same view point as FIG. 1 showing the sickle bar in an upwardly angulated position.

FIG. 3 is an orthographic rear elevational view of the mower of FIG. 1 showing the sickle bar in phantom outline in an upwardly angled position such as that shown in FIG. 2.

FIG. 4 shows the folding of the mower to more compact structure for storage or transport, with FIG. 4A presenting a rearward looking isometric view of the left side with the sickle bar horizontally extended, FIG. 4B presenting a forward looking view of the right side with the sickle bar and handle folded and FIG. 4C presenting an orthographic right side elevational view with the handle and sickle bar in folded mode.

FIG. 5 is an enlarged partially cut-away isometric view of a first form of lower transmission structure for oscillating a single cutting blade relative to a stationary notched cutting bar.

FIG. 6 is an enlarged lateral cross-sectional view through the transmission and sickle bar structure of FIG. 5 having two adjacent reciprocally oscillating toothed cutter bars, taken on line 6-6 in FIG. 5 in the direction indicated by the arrows.

FIG. 7 is an enlarged partially cut away isometric view of the transmission structure embodying a second commonly known mechanical linkage to oscillate two adjacent reciprocating toothed cutting blades relative to each other with the drive shaft angled at an included angle to the sickle bar structure greater than 90°.

FIG. 8 is an enlarged partial vertical cross-sectional view through the mechanism of FIG. 7, taken on the line 8-8 thereon in direction indicated by the arrows.

FIG. 9 is an enlarged horizontal cross-sectional view through the mechanism of FIG. 7, taken on the line 9-9 thereon in the direction indicated by the arrows.

### V. DESCRIPTION OF THE PREFERRED EMBODIMENT

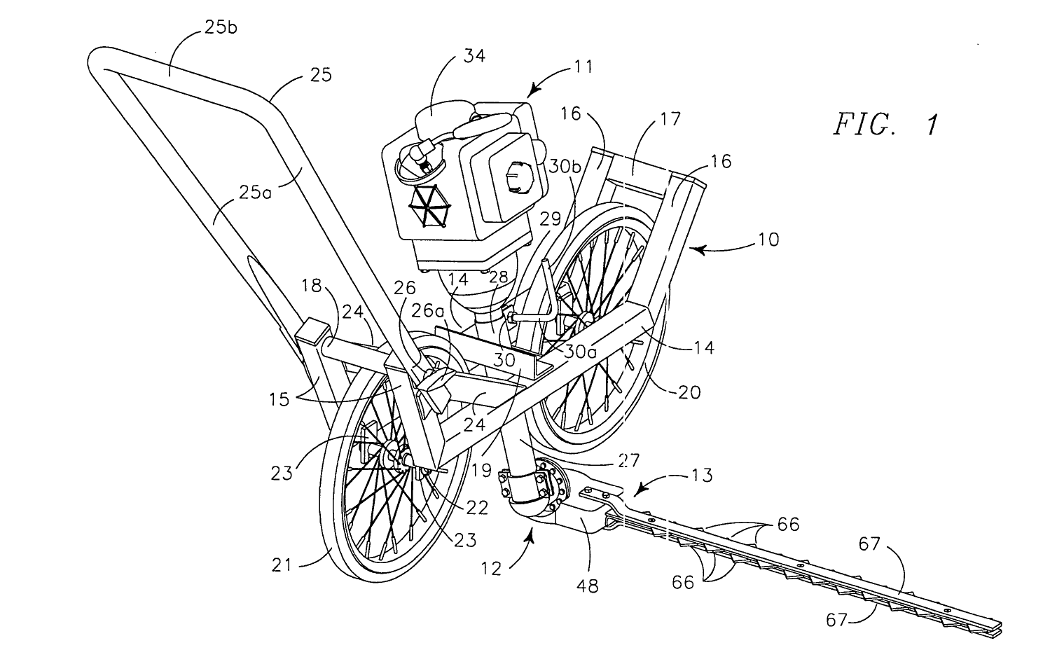

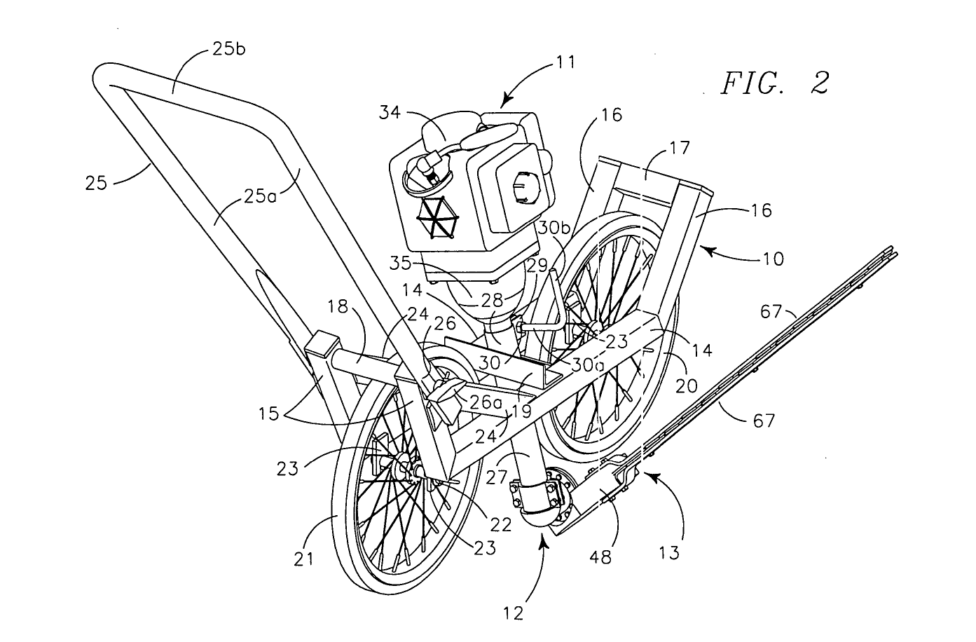

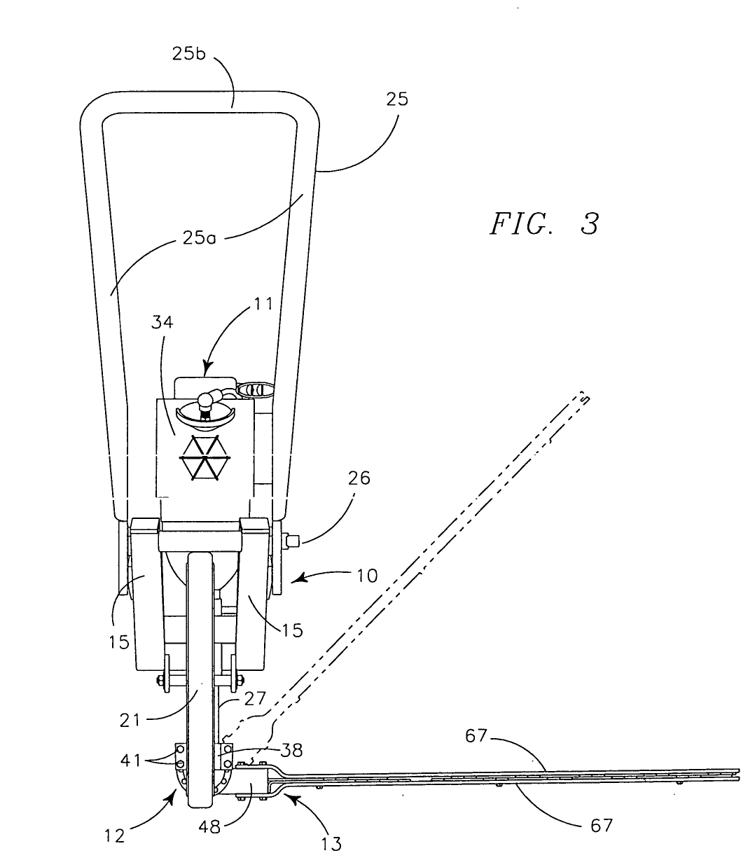

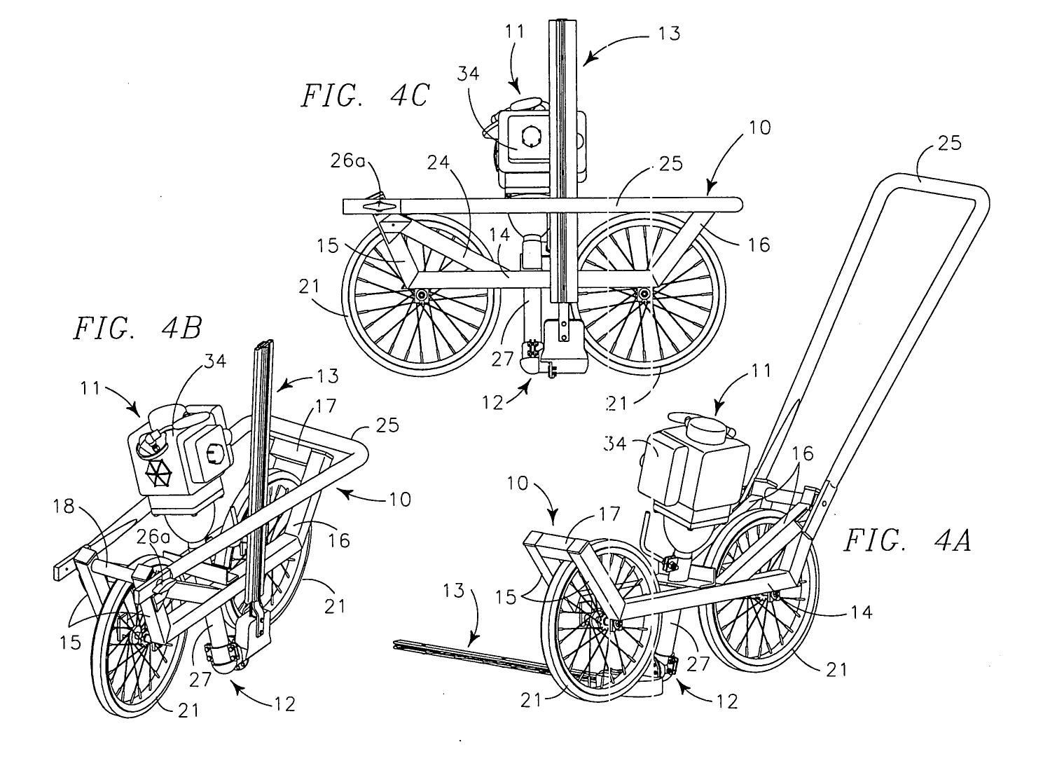

As shown in FIG. 1, ground supported frame 10 carries medial vertical adjustably positionable power structure 11 having in its lower portion transmission 12 and pivotally carrying laterally extendable sickle bar 13.

Frame 10 is formed with two similar side beams having linear medial portions 14, somewhat more angulated upturned rearward portions 15 and somewhat less angulated upturned forward portions 16. Forward ends of forward portions 16 are joined in laterally spaced relationship by forward cross beam 17 and the rearward ends of rearward portions 15 are joined in similar laterally spaced relationship by rearward cross beam 18. The medial portions 14 of the side beams are joined by angle type medial cross beam 19 to create the structurally interconnected frame 10 illustrated. The angulation and dimensioning of rearward portions 15 and forward portions 16 of the side beams is such as to allow rotation of forward wheel 20 and rearward wheel 21 that support the frame for locomotion over a supporting surface. Wheels 20, 21 are supported for rotation in bearing type journals 22 carried by brackets 23 depending from each respective end of medial portions 14 of the side beams. The wheels 20, 21 are aligned in a vertically elongate plane extending medially between the side beams 14. The dimensioning and configuration of wheels 20, 21 and forward and rearward portions 15, 16 of the side beams are so determined that the wheels 20, 21 may freely rotate in their journals 22 without interference from forward and rearward cross-beams 17, 18 respectively or from the side beams 14.

Frame 10 provides angulated supports 24 extending from the upper part of each rearward portion 15 of each side beam angularly downwardly to the upper surface of the medial part 14 of the associated side beam to provide additional strength and rigidity for the rearward portion of the frame. U-shaped manipulating handle 25 has angulated depending legs 25a and uppermost handle bar 25b. The lower portion of each leg 25a is adjustably pivotably mounted to the laterally outer surfaces of each opposed rearward portion 15 of each side beam by nut-bolt combinations 26. Preferably nut 26a has a handle-like configuration to aid manual manipulation in tightening and loosening on the bolt so that the associated bolt may be manipulated to allow folding of the handle structure and adjustment of its angular position relative to the frame 10.

Powering structure 11 provides tubular powering column 27 slideably mounted for vertical adjustment in collar 28 structurally carried by medial cross-beam 19 of the frame about a hole defined in the horizontal arm of that cross-beam 19 to allow passage of the powering column 27 therethrough. The powering column collar 28 is of a split type with two spacedly adjacent tightening ears 29 carried on each side of the split to receive nut-bolt combination 30 extending through aligned holes defined in the ears 29 to allow adjustment of the frictional contact of the collar 28 with powering column 27 to allow adjustment of the vertical position of powering column relative to the collar 28 and thusly relative to the frame 10. Preferably the bolt portion 30a of nut-bolt combination 30 has a bent shaft portion 30b to aid manual manipulation in tightening and loosening the nut-bolt combination.

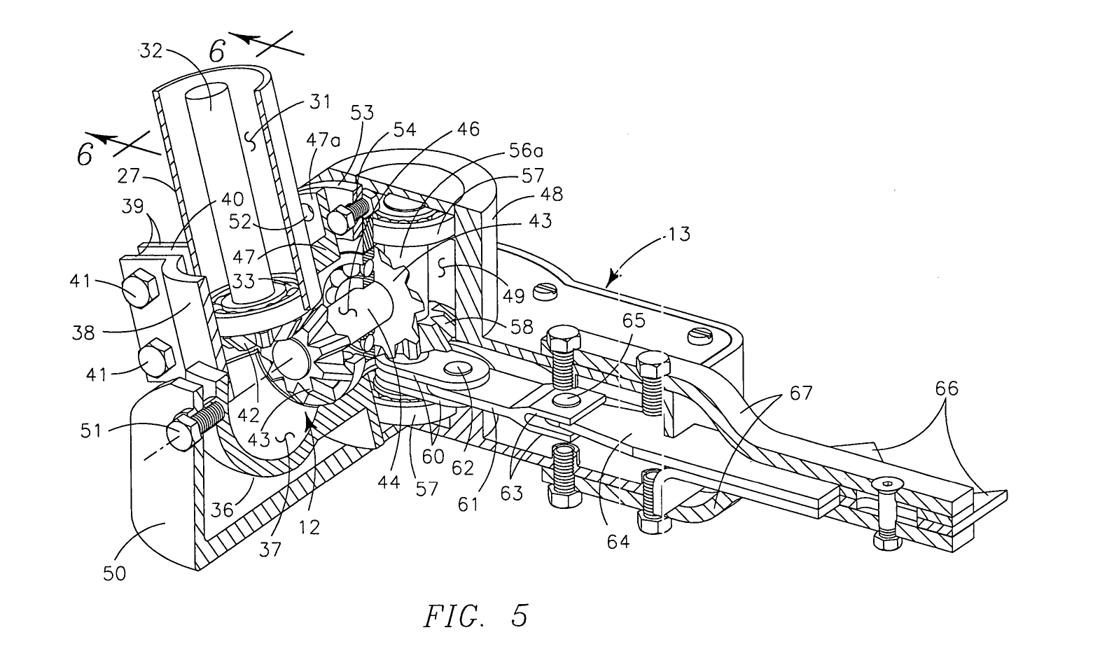

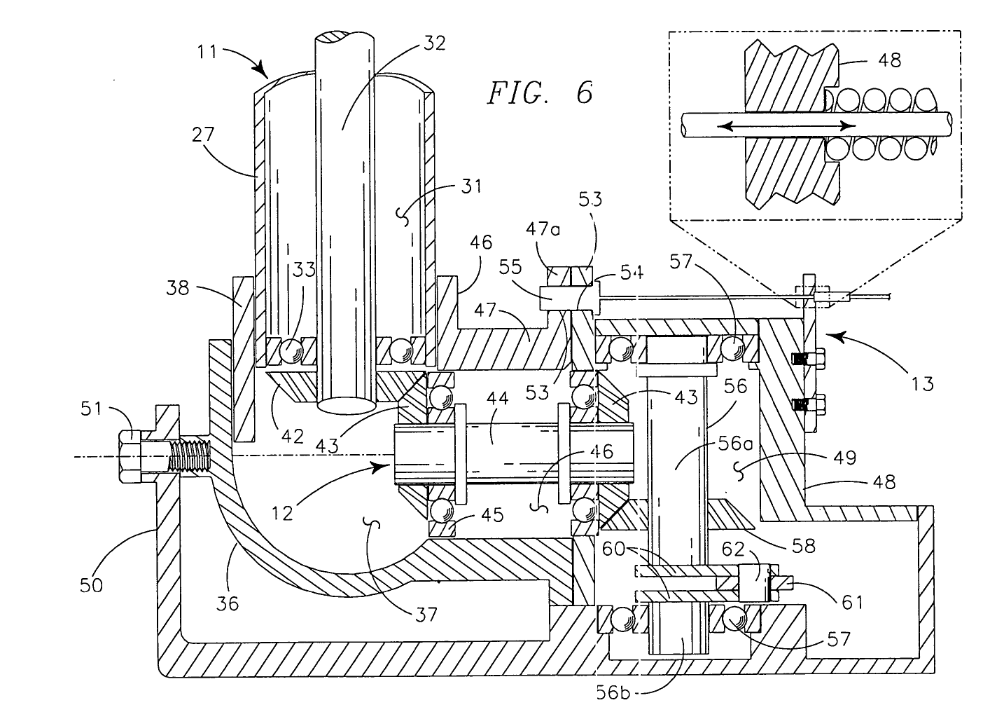

As seen in FIGS. 5 and 6 the powering column 27 defines medial channel 31 to allow passage of powering shaft 32 therethrough. The powering shaft 32 is journaled in axial alignment in channel 31 by at least one bearing 33, and preferably by two axially spaced bearings (not shown), carried within channel 31. The upper portion of powering column 27 operatively communicates with motor 34, in the instance illustrated comprising a gasoline powered type motor, carried by the upper portion of the powering shaft 32 of the motor 34. Other types of motors than those powered by fossil fuels are equally well adapted to use with my mower, especially such as electrically powered motors. The motor 34 communicates through appropriate known linking structure carried in depending housing 35 to operatively rotate powering shaft 32 and has known control devices to allow starting, stopping and speed variation. The operating devices for these controls may be positioned on the motor structure itself or remotely on a manipulating handle 25 as desired.

The lower end portion of powering column 11 carries transmission structure 12 having casement 36 defining chamber 37 for containment of the transmission bearing. The upper portion of casement 36 provides cylindrical split collar 38 to fasten about the lower end portion of powering column 27. The split collar has fastening ears 39 extending radially outwardly on each side of slit 40 with nut-bolt combinations 41 extending between fastening ears 39 to releasably fasten collar 38 about the outer surface of the lower portion of the powering column 27. The lower portion of powering shaft 32 carries angled beveled gear 42 to rotate about a vertical axis and intermesh with similar angled bevel gear 43 to translate rotary motion of vertical powering shaft 32 into horizontal rotary motion of jack shaft 44 carrying the bevel gear 43. The jack shaft 44 is journaled in bearing 45 carried in the forwardly extending jack shaft channel 46 of casement 36 extending forwardly spacedly therebeyond to communicate with the sickle bar structure 13. The forward end portion of casement 36 defines circularly annular disk 47 to fit adjacent the sickle bar structure and allow pivotal motion of that structure relative to the transmission structure 12.

Sickle bar structure 13 provides casement 48a with disk-like portions that fits immediately forwardly of the forward surface of annular disk 47 of the transmission structure for pivotal motion of the casement 48 in a vertical plane about the axis of jack shaft 44. The casement 48 defines chamber 49 to carry mechanical linkage communicating between the sickle bar structure and the transmission structure.

The pivotal motion of casement 48 relative to casement 36 may be provided in various fashions, which are within the ambit and scope of my invention. One convenient method is illustrated in FIGS. 5 and 6 where it is seen that portion 50 of the body of casement 48 extends beneath casement 36 and upwardly along the side of casement 36 distal from casement 48 where that portion 50 is pivotally attached to casement 36 by bolt 51 which is axially aligned with the axis of jack shaft 44. Other known mechanical linkages which accomplish this function are equally well within the ambient and scope of my invention as the only mechanical requirement is that the casement 48 pivot relative to the casement 36 about the extended axis of jack shaft 44 to allow the sickle bar 13 to pivot and be continuously powered in various angular positions by powering shaft 32 by use of gearing linkage such as that illustrated.

The flange 47a carried by angular disk 47 defines a plurality of circumferentally spaced holes 52 and a similar flange 53 on the abutting surface of casement 48 defines a similarly arrayed plurality of circumferentally spaced holes 54 that may be aligned with the holes 52. Pin 55 (FIG. 6) is inserted through two aligned holes 52, 54 to maintain the sickle bar casement 48 in a particular desired angular relationship relative to transmission casement 36. The pin 55 may be manually positionable or may be spring biased and manually controllable from the area of the handle bar 25 by lever 55a if desired.

A first species of known and commonly used mechanical linkage for translating rotary motion of shaft 44 to a single cutter bar is shown in FIGS. 5 and 6.

Casement 48 journals vertically oriented split pinion shaft 56 in vertically spacedly opposed bearings 57. The pinion shaft 56 in its medial upper portion irrotably carries beveled pinion 58 operatively engaged with beveled gear 43 irrotatably carried on the forward end portion of jack shaft 44 to transmit rotary motion of power shaft 32 to pinion shaft 56.

The lower end portion of the upper part 56a of pinion shaft 56 and the upper end portion of lower part 56b of the pinion shaft 56 both irrotably carry sickle bar cams 60, spaced to movably receive the inner end portion of sickle bar yoke 61 therebetween. The sickle bar yoke 61 is pivotally journaled on sickle bar pin 62 so that the vertical rotary motion of pinion shaft 56 will be translated to perpendicular oscillatory motion of the sickle bar yoke 61 as heretofore known in the sickle bar cutting arts. The sickle bar yoke 61 at its laterally outer end provides yoke legs 63 defining a space therebetween to movably receive the inner end of cutter bar 64 which is journaled between the legs 63 by pin 65 extending through legs 63 and the inner end portion of cutter bar 64. The cutter bar 64 is an elongate element having a plurality of similar spacedly adjacent triangular teeth 66 (FIG. 1) defined on both forward and rearward edges and is carried between two similar support bars 67 for elongate oscillatory motion therebetween to cut vegetation in either a forward or rearward direction.

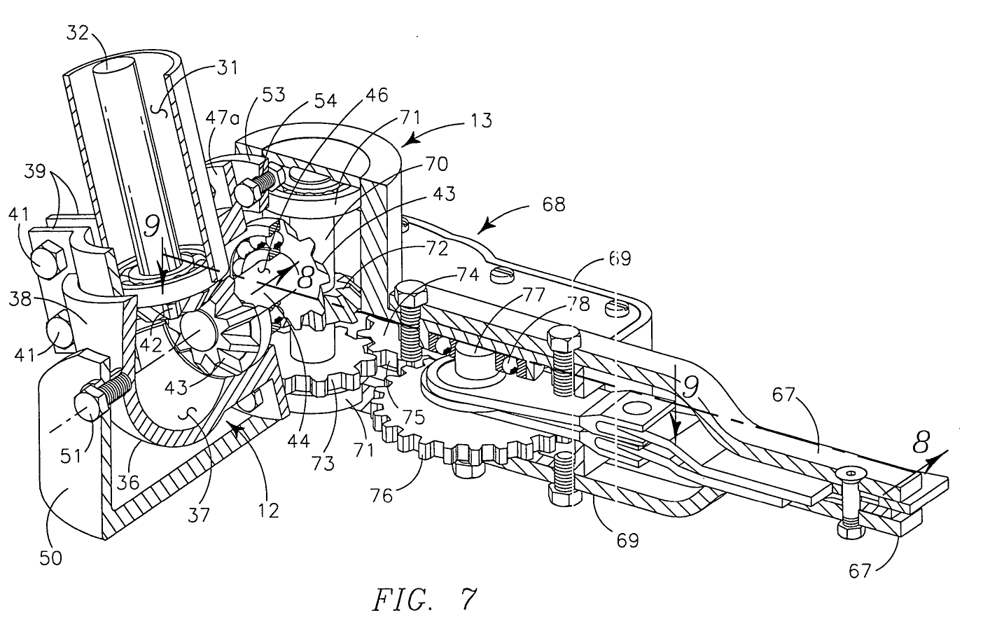

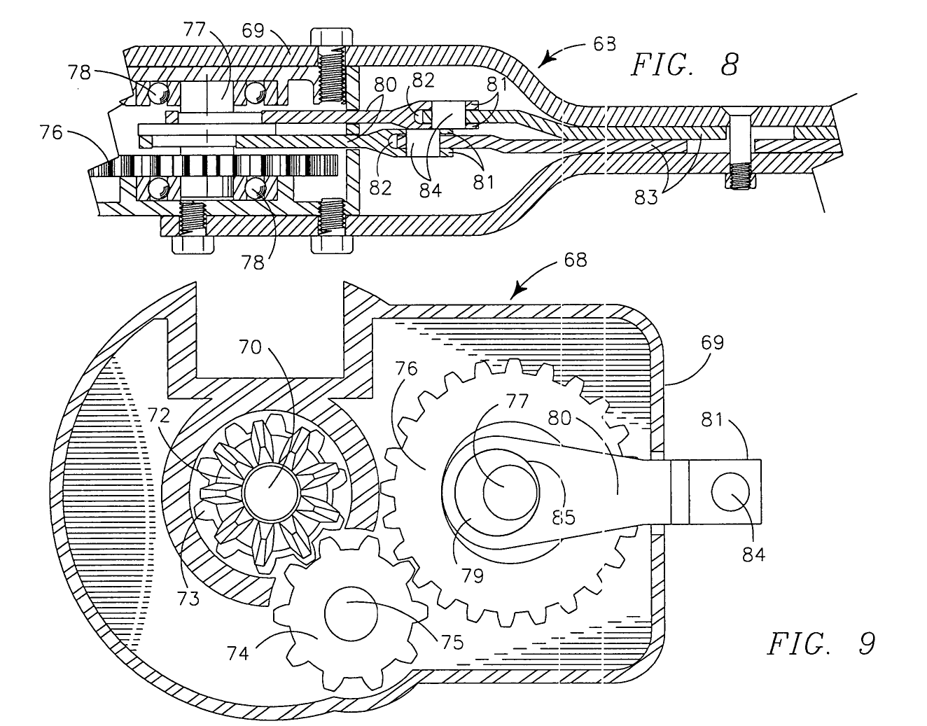

A second known and commonly used mechanical linkage for translating rotary motion of a shaft perpendicular to two relatively oscillating cutter blades 83 of a sickle bar 13 is shown in FIGS. 7-9. Here the transmission structure 12 is substantially the same as that described for the first species of motion translating linkage of FIG. 5-6 and its parts are labeled with the same numbers as used for the same parts of the first species to aid understanding.

In this second species of motion translator the sickle bar structure 68 provides casement 69 which is comparable to casement 48 of the first species. The casement 69 carries pinion shaft 70 journaled in vertically spacedly opposed bearings 71. The pinion shaft 70 irrotatably carries pinion 72 in its medial portion to operatively intermesh with bevel gear 43 carried on jack shaft 44 of the transmission structure 12 to transmit the horizontally oriented rotation of jack shaft 44 to vertically oriented rotation of pinion shaft 70. A lower portion of pinion shaft 70 irrotatably carries disk gear 73 which in turn intermeshes with idler disk gear 74 journaled on shaft 75 carried by casement 69. Idler disk gear 74 intermeshes with cutter driving disk gear 76. The cutter blade driving disk gear 76 is irrotatably carried on shaft 77 supported in vertically spacedly opposed bearings 78 carried by casement 69.

The shaft 77 irrotatably carries two vertically spaced circular driving cams 79 that are eccentrically carried on the shaft 77 with diametrically opposed eccentricity. Each driving cam 79 is rotatably carried in the laterally end portion of similar blade yokes 80 in holes 85 defined therein. Each of the elongate blade yokes 80 have vertically spaced legs 81 in their laterally outer end portions defining blade channel 82 to receive the inner end portions of cutter blades 83 therein. The laterally inner end portion of each cutter blade 83 is rotatably mounted in one blade channel 82 by pin 84 extending through holes defined in the blade yoke legs 81 and through hole 84 defined in the blades.

With this linkage as pinion shaft 70 rotates, its rotation will be translated through disk gear 73, 74, 76 to rotate driving shaft 77. As driving shaft 77 rotates driving cam 79 will be rotated about the axis of driving shaft 77 and will cause driving cam 79 to rotate eccentrically about the driving shaft 77. Since the driving cams 79 are rotatably carried in blade yokes 80, rotation in those blade yokes will be translated into an oscillatory linear motion of the blade yokes with each blade yoke being 180° out of phase with the other. This oscillating motion of the blade yokes 80 will cause resultant oscillatory motion of cutter blades 83 relative to each other and cause a cutting between the teeth 66 of the blades.

The species of sickle bar structures described are known, commercially available and commonly used, especially in hedge and herbage trimmers and are not novel per se. Various other similar known cutter bar structures that accomplish the same purpose and results, such as single cutter bars that oscillate relatively to a fixed tooth cutter bars and sickle bars that have two or more blades that oscillate relatively to each other by means other than those described herein remain within ambit and scope of my mower and are operative therewith though they may not be as efficient or useful as the cutter bar structures described still.

Having described the structure of my mower its operation may be readily understood.

A mower formed according to the foregoing specification, if in a compact mode, is changed manually to an assembled operative mode by releasing the nut-bolt combinations 26, manually moving the U-shaped manipulating handle 25 to the desired rearwardly extending angulated position for comfortable use and retightening the nut-bolt combinations 26 to maintain this position. The mower then is moved to an area where it is to be used by appropriate manual manipulation as aided by wheels 20, 21, normally with the sickle bar 13 facing upwardly on a sloping surface to be mowed.

The sickle bar 13 then is moved to an angular position that is substantially parallel to the angulated surface of the herbage structure to be mowed. This is accomplished by removing the pin 55 from its fastening position, manually moving the sickle bar to the appropriate position and re-establishing the pin 55 in holes 52, 54 to maintain the desired angular position during the current mowing operation. The vertical position of the surface to be cut by the mower is then determined and established by vertically moving the powering structure 11 relative to the mower frame 10. This motion is accomplished by loosening nut-bolt combination 30, manually manipulating the powering structure 11 to the appropriate vertical position and subsequently retightening the nut-bolt combination 30, as aided by bent portion 30b and bolt shaft 30a, to maintain the desired vertical position.

The motor 34 of the powering structure then is started, controlled for appropriate cutting speed and the mower is ready for cutting. To cut an herbage surface the mower is manually manipulated by handle 25 to move along a selected course determined to cut herbage on the surface to be serviced. Preferably the mower is moved either in sequential courses parallel to the periphery, or portion thereof, of the area to be cut or on contour lines of a sloping surface to be cut. The mower easily may be moved on lines angled to either contour lines or lines parallel to any of the periphery of an area to be serviced, but often this operation may not be as simple or efficient as moving the mower in the preferred modes.

It is to be noted from the foregoing description that the sickle bar cutter structure illustrated does not have guards about its exposed teeth. Such guards if desired are well known in the prior art and may be used with my sickle bar cutter without departing from its spirit, essence, or scope, though such guards are not necessary or an essential element for the instant mower or its operation.

1. A mower structure for cutting herbage comprising in combination:
a frame having forward and rearward ends and journaling two wheels in elongately spaced co-planar relationship for support on and locomotion over a supporting surface;
a vertically oriented powering structure having upper and lower end portions and coupled to the frame
for adjustable vertical motion relative to the frame; and
a sickle bar structure pivotally carried by the lower portion of the powering structure for adjustable continuous pivotal motion in a laterally extending vertical plane.

2. (Cancelled)

3. The mower structure of claim 1 wherein the powering structure has a medial tubular powering column with a motor at an upper end portion of the powering column operatively communicating with a power shaft depending through the powering column to operatively engage a transmission structure carried by a lower portion of the powering column to operate the sickle bar.

4. The mower structure of claim 3 wherein the sickle bar structure is pivotally carried by the transmission structure; and
the sickle bar structure operatively communicates with the transmission structure to cause oscillatory motion of at least one cutter bar in the sickle bar structure responsive to rotary motion of transmission structure elements.

5. The mower structure of claim 1 wherein the sickle bar structure provides an elongate cutter bar that oscillates between upper and lower support bars and has a plurality of sequentially adjacent cutter teeth on both a forward edge and a rearward edge to allow cutting by moving the mower in a forward and a rearward direction.

6. The mower structure of claim 1 further having an elongate manipulating handle carried by the rearward end of the frame and extending upwardly and rearwardly from the frame, said manipulating handle having means for angular adjustment in an elongately extending vertical plane.

7. The mower structure of claim 6 wherein
the sickle bar structure is foldable substantially vertically upward adjacent the frame and the manipulating handle is foldable forwardly over the frame and over the sickle bar structure to form a compact mower structure for periods of non-use and transport.

8. A mower structure for cutting herbage comprising in combination:
an elongate frame, having forward and rearward ends, journaling two elongately spaced co-planar wheels for support and locomotion on a supporting surface and having a manipulative handle adjustably extending upwardly and rearwardly from the rearward end of the frame;
a vertically oriented powering structure carried by the frame for adjustable vertical motion relative to the frame, said powering structure having a medial tubular powering column with a motor at an upper end portion of the powering column operatively communicating with a powering shaft depending through the powering column to operatively engage a transmission structure carried by a lower portion of the powering column; and
a sickle bar structure carried by the transmission structure for adjustable continuous pivotal positioning in a laterally extending vertical plane, said sickle bar structure operatively communicating with the transmission structure and having
at least one elongate cutter bar with a plurality of sequentially adjacent cutter teeth on both a forward edge and a rearward edge, and
means to translate rotary motion of the transmission structure to oscillatory motion of the at least one elongate cutter bar in the sickle bar structure to allow cutting in both a forward and rearward direction responsive to forward and rearward motion of the mower.

9. The mower structure of claim 8 wherein the at least one cutter bar comprises:
at least two similar adjacent cutting bars reciprocating 180 degrees out of phase with each other.

10. The mower structure of claim 8 wherein the sickle bar structure folds upwardly adjacent a side of the frame and the manipulative handle folds forwardly and downwardly over the sickle bar structure and to the frame for compaction of the mower during periods of non-use.
